(19) United States
(12) Patent Application Publication
(10) Pub. No.: US 2019/0057324 A1
(43) Pub. Date: Feb. 21, 2019

(54) PREDICTING UN-CAPACITATED FREIGHT DEMAND ON A MULTI-HOP SHIPPING ROUTE

(71) Applicant: INTERNATIONAL BUSINESS MACHINES CORPORATION, Armonk, NY (US)

(72) Inventors: Raphael Ezry, New York, NY (US); Munish Goyal, Yorktown Heights, NY (US)

(21) Appl. No.: 15/680,582

(22) Filed: Aug. 18, 2017

(51) Int. Cl. G06Q 10/02; G06N 5/04; G06Q 30/02

(52) U.S. Cl. CPC G06Q 10/02; G06Q 30/0207; G06N 5/04

(57) ABSTRACT

Systems and methods for predicting un-capacitated freight demand on a multi-hop shipping route are disclosed. In embodiments, a computer-implemented method, comprises: receiving daily customer booking data from one or more remote servers; determining an estimated customer arrival pattern for each port on a shipping route of a shipping vessel based on the customer booking data; determining an estimated blocking probability for each of the ports on the shipping route due to shipping capacity constraints, upstream bookings and downstream bookings; determining an estimated probability of booking cancellations for each of the ports on the shipping route; determining an estimate of how much freight will be loaded onto the shipping vessel for each of the ports; calculating un-capacitated shipping demand for each of the ports; and determining un-capacitated demand per day for each of the ports of the shipping route based on the capacitated demand and the estimated customer arrival pattern.

### BACKGROUND

The present invention relates generally to shipping demand forecasting, and more particularly, to predicting un-capacitated freight demand on a multi-hop shipping route.

Managing the shipping of freight containers between a plurality of stopping points or hops on a shipping route involves consideration of many different factors. Typically, customers book an amount of goods to be shipped with a shipping management company (e.g., a number of shipping containers) for shipping by a select date, and are provided with an estimated cost for the shipping by the shipping management company. If a shipping management company determines that no shipping capacity is available, then potential customers will be blocked from booking a shipment. As the select shipping date approaches, the shipping management companies will provide a final cost for shipping to booked customers. Typically, the shipping management companies will offer discounts to customers, the amount of which is determined by how full the shipping vessel is. That is, if the shipping vessel of a shipping management company is not utilized to its full capacity, discounts may be offered to customers to incentivize them to ship their goods with that shipping management company, so as to maximize utilization of the shipping vessel. Customers will decide which shipping management company they want to ship their goods with (e.g., based on price, dates of departure, etc.), and will cancel their bookings with the remaining shipping companies. Thus, various shipping management companies may be competing with one another to maximize utilization of their shipping vessels.

In some cases, capacitated demand data is utilized by shipping management companies to build demand forecasting models in an attempt to better manage the shipping of freight. Capacitated demand is defined as the portion of the given demand that can be served by a network without violating capacity constraints on any of the network's facilities.

### SUMMARY

In an aspect of the invention, a computer-implemented method includes: receiving, by a computing device, daily customer booking data from one or more remote servers; determining, by the computing device, an estimated customer arrival pattern for each port on a shipping route of a shipping vessel based on the customer booking data; determining, by the computing device, an estimated blocking probability for each of the ports on the shipping route due to shipping capacity constraints, upstream bookings and downstream bookings; determining, by the computing device, an estimated probability of booking cancellations for each of the ports on the shipping route; determining, by the computing device, an estimate of how much freight will be loaded onto the shipping vessel for each of the ports on the shipping route; calculating, by the computing device, un-capacitated shipping demand for each of the ports on the shipping route; and determining, by the computing device, un-capacitated demand per day for each of the ports of the shipping route based on the capacitated demand and the estimated customer arrival pattern.

In another aspect of the invention, there is a computer program product for predicting un-capacitated freight demand on a multi-hop shipping route. The computer program product comprises a computer readable storage medium having program instructions embodied therewith. The program instructions are executable by a computing device to cause the computing device to: determine an estimated customer arrival pattern for each port on a shipping route of a shipping vessel by calculating a maximum likelihood estimate of parameters of a beta distribution and seasonality booking patterns; determine an estimated blocking probability for each of the ports on the shipping route due to shipping capacity constraints, upstream bookings and downstream bookings; determine an estimated probability of booking cancellations for each of the ports on the shipping route; determine an estimate of how much freight will be loaded onto the shipping vessel for each of the ports on the shipping route; calculate un-capacitated shipping demand for each of the ports on the shipping route; and determine un-capacitated demand per day for each of the ports of the shipping route by convolving the determined un-capacitated demand and the determined estimated customer arrival pattern.

In another aspect of the invention, there is a system for predicting un-capacitated freight demand on a multi-hop shipping route The system includes a CPU, a computer readable memory and a computer readable storage medium associated with a computing device; program instructions to receive daily customer booking data from one or more remote client servers, the booking data including observed carried load data; program instructions to determine an estimated customer arrival pattern for each port on a shipping route of a shipping vessel by calculating a maximum likelihood estimate of parameters of a beta distribution and seasonality booking patterns; program instructions to determine an estimated blocking probability for each of the ports on the shipping route due to shipping capacity constraints, upstream bookings and downstream bookings; program instructions to determine an estimated probability of booking cancellations for each of the ports on the shipping route based on estimated bargaining positions of a customer and a booking company using a non-linear regression method and asymptotic limit argument; program instructions to determine an estimate of how much freight will be loaded onto the shipping vessel for each of the ports on the shipping route based on observed carried load data; program instructions to calculate un-capacitated shipping demand for each of the ports on the shipping route; and program instructions to determine un-capacitated demand per day for each of the ports of the shipping route by convolving the determined un-capacitated demand and the determined estimated customer arrival pattern; wherein the program instructions are stored on the computer readable storage medium for execution by the CPU via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a computing infrastructure according to an embodiment of the present invention.

FIG. 2 shows an exemplary environment in accordance with aspects of the invention.

FIG. 3 illustrates an exemplary shipping route for a shipping vessel in accordance with aspects of the invention.

FIG. 4 illustrates a shipping management scenario for a shipping vessel in accordance with aspects of the invention.

FIG. 5 shows a flowchart of steps of a method in accordance with aspects of the invention.

FIGS. 6 and 7 are graphs representing estimated distributions of customer booking dates conditional on vessel departure date in accordance with aspects of the invention.

FIG. 8 depicts the convolution of estimated customer arrival patterns of FIG. 6 and un-capacitated demand per shipping vessel departure of FIG. 5 to predict daily customer arrivals in accordance with aspects of the invention.

FIG. 9 depicts unrealized potential bookings as the difference between determined capacitated demand and un-capacitated demand in accordance with aspects of the invention.

### DETAILED DESCRIPTION

The present invention relates generally to shipping demand forecasting, and more particularly, to predicting un-capacitated freight demand on a multi-hop shipping route. Typically, shipping management companies compete with one another to maximize utilization of their shipping vessels by negotiating pricing deals with customers. As the shipping demand information at downstream ports is not available at the time of price negotiation due to long voyages, it is very challenging for business managers at each port on a route to ascertain the right price and load trade off during negotiations with customers. Typical methods of forecasting based on capacitated demand fail to provide sufficient forecasting data. More specifically, demand for shipping containers cannot be approximated as a fluid flow, such that capacitated demand forecasting methods lead to fitting random noise as if they were the real capacitated demand.

In embodiments, a system of the invention performs the following steps: 1) estimate a time of arrival of customers for container booking (lead time); 2) estimate a likelihood that the arriving customer are not booked due to vessel capacity; 3) estimate a likelihood that the booked customer would reject the final price and instead ship with a competitor; 4) estimate the un-capacitated demand or the demand if the final price offered were zero by triangulating the actual offered price with the actual carried container demand; and 5) perform an index based method to set mapping between price and the ratio of predicted un-capacitated demand and the sales before the arrival of the îth customer.

In embodiments, a price discount offered to an arriving customer by a shipping manager may be based on the following. At a time t, when a customer arrives for a final price negotiation with a business manager at port j; predicted un-capacitated demand at port k is D(k,t); the sold capacity at port k is S(k,t); and the total unsold open bookings at port k is B(k,t); then the price discount offered to the arriving customer is based on the value of:

R(k,t)=[D(k,t)/(S(k,t)*B(k,t))]/[sum(k in downstream)D(k,t)/(S(k,t)*B(k,t))].

If R(k,t)>threshold (1) then the discount offered is d(1), which is proportional to the corresponding threshold (Threshold(1)).

In embodiments, a system and method is provided for predicting un-capacitated multi-hop freight demand. While capacitated demand is a portion of a given demand that can be served by a shipping network without violating capacity constraints on the shipping network's facilities, un-capacitated demand is the demand when the shipping network capacity is infinite (generally unobserved). In embodiments, the system predicts a number of new customer bookings for each pair of ports on a shipping route for vessels having infinite carrying capacity (e.g., un-capacitated freight demand on multi-hop routes) utilizing cargo load data. Knowledge of un-capacitated demand enables planning for shipping vessel type, shipping vessel frequency, ports of call, adjustments to business cycles and shipping container count by type (e.g., refrigerated, dry, tank, etc.). Estimating and predicting un-capacitated demand on a multi-hop route is a challenge, as capacity constraints of a shipping vessel get coupled, and it becomes difficult to remove the coupling from observed capacitated demand data. In embodiments, the invention enables estimating and predicting un-capacitated demand on a multi-hop shipping route utilizing vessel capacity utilization data and macroeconomic dynamics data for various countries/ports along the shipping route.

Unlike traditional methods of demand forecasting in the transportation industry that predict only capacitated demand, embodiments of the present invention provide an improvement in the field of demand forecasting by providing a system and method whereby un-capacitated demand can be forecasted taking into account the impact of local negotiations (e.g., port-specific negotiations) between customers and shipping management companies. By enabling valuation of negotiating power, embodiments of the present invention increase the functionality of a demand forecasting server and enable improved demand data output to customers (i.e., remote customer servers). In aspects, a demand forecasting server of the present invention is configured to provide estimated un-capacitated demand per day for a shipping route to multiple remote negotiators (e.g., shipping management companies) in real-time.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

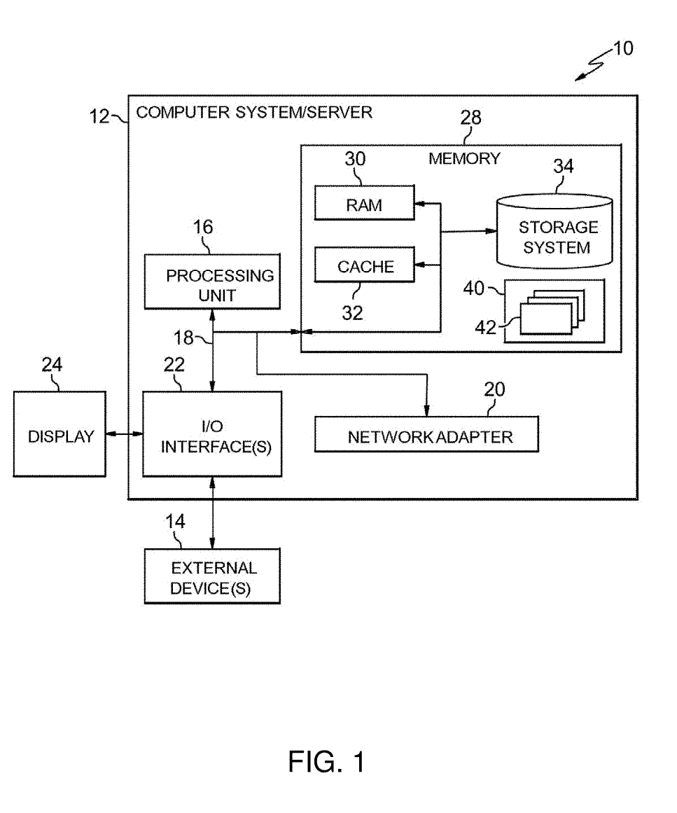

Referring now to FIG. 1, a schematic of an example of a computing infrastructure is shown. Computing infrastructure 10 is only one example of a suitable computing infrastructure and is not intended to suggest any limitation as to the scope of use or functionality of embodiments of the invention described herein. Regardless, computing infrastructure 10 is capable of being implemented and/or performing any of the functionality set forth hereinabove.

In computing infrastructure 10 there is a computer system (or server) 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system executable instructions, such as program modules, being executed by a computer system. Generally, program modules may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system 12 in computing infrastructure 10 is shown in the form of a general-purpose computing device. The components of computer system 12 may include, but are not limited to, one or more processors or processing units (e.g., CPU) 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

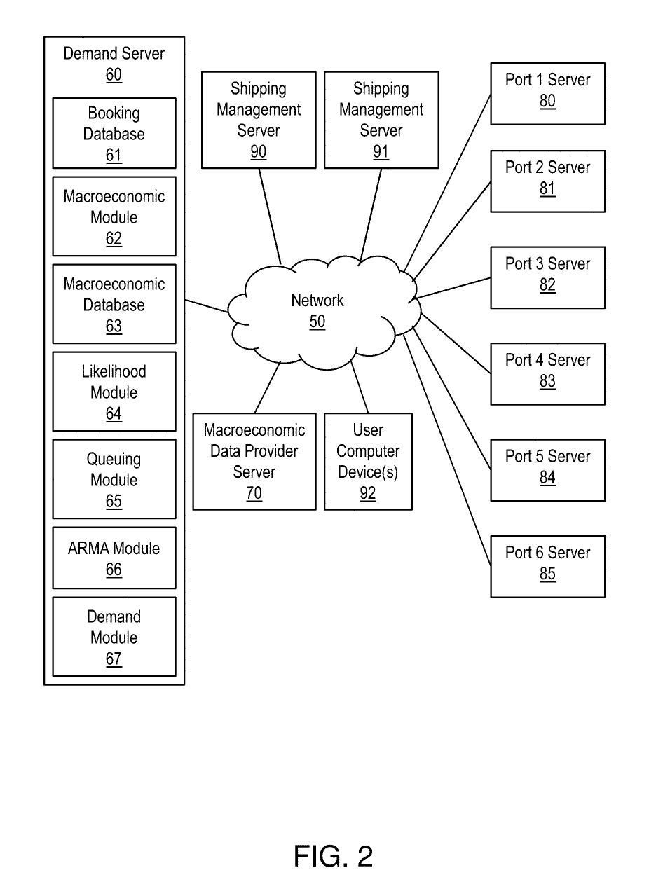

FIG. 2 shows an exemplary environment in accordance with aspects of the invention. The environment includes a demand server 60 connected to a network 50. The demand server 60 may comprise a computer system 12 of FIG. 1, and may be connected to the network 50 via the network adapter 20 of FIG. 1. The demand server 60 may be configured to send and/or receive information from one or more sources of freight shipping data, such as port management servers represented in FIG. 2 by port servers 80-85. The demand server 60 may be configured as a special purpose computing device that is part of a service infrastructure providing freight demand information to one or more customers. For example, the demand server 60 may be configured to provide shipping demand information to one or more shipping management companies, represented in FIG. 2 by the shipping management servers 90 and 91. The demand server 60 may also be configured to communicate with one or more user computer device 92 (e.g., consumers who are booking shipping containers, third party booking agents, etc.) through the network 92.

The network 50 may be any suitable communication network or combination of networks, such as a local area network (LAN), a general wide area network (WAN), and/or a public network (e.g., the Internet). The demand server 60 may be in further communication with one or more sources of macroeconomic data (represented by macroeconomic data provider server 70) via the network 50. Sources of macroeconomic data may include any third party source of economic data, including trade associations, universities, government agencies, etc.

Still referring to FIG. 2, the demand server 60 may include one or more of a booking database 61, a macroeconomic module 62, a macroeconomic database 63, a likelihood module 64, a queuing module 65, an autoregressive-moving-average (ARMA) module 66 and a demand module 67. Various modules of the demand server 60 may be configured to perform one or more of the functions described herein, and may include one or more program modules (e.g., program module 42 of FIG. 1) executed by the demand server 60. In embodiments, the macroeconomic module 62 is configured to receive macroeconomic data from one or more third party sources (e.g., the macroeconomic data provider server 70), and store the data in the macroeconomic database 63 for use by the demand server 60. In aspects, the likelihood module 64 is configured to determine customer arrival (customer booking) patterns. In embodiments, the queuing module 65 is configured to determine an estimated blocking probability due to shipping capacity of a shipping vessel, and determine an estimated probability of cancellation due to negotiations. In aspects, the ARMA module 66 determines an estimate of how much freight will be loaded for a particular shipping vessel. In embodiments, the demand module 67 calculates capacitative demand. It should be understood that the demand server 60 may include additional or fewer components than those shown in FIG. 2. In embodiments, separate components may be integrated into a single computing component or module. Additionally, or alternatively, a single component may be implemented as multiple computing components or modules.

For the sake of simplicity, the term “port” is utilized herein to reference a freight loading and unloading point along a freight route; however, it should be understood that the present invention is not intended to be limited to the transportation of goods via watercraft. Likewise, the term “shipping vessel” is utilized herein for the sake of simplicity, but it should be understood that land-based transportation vessels may be utilized in conjunction with the present invention.

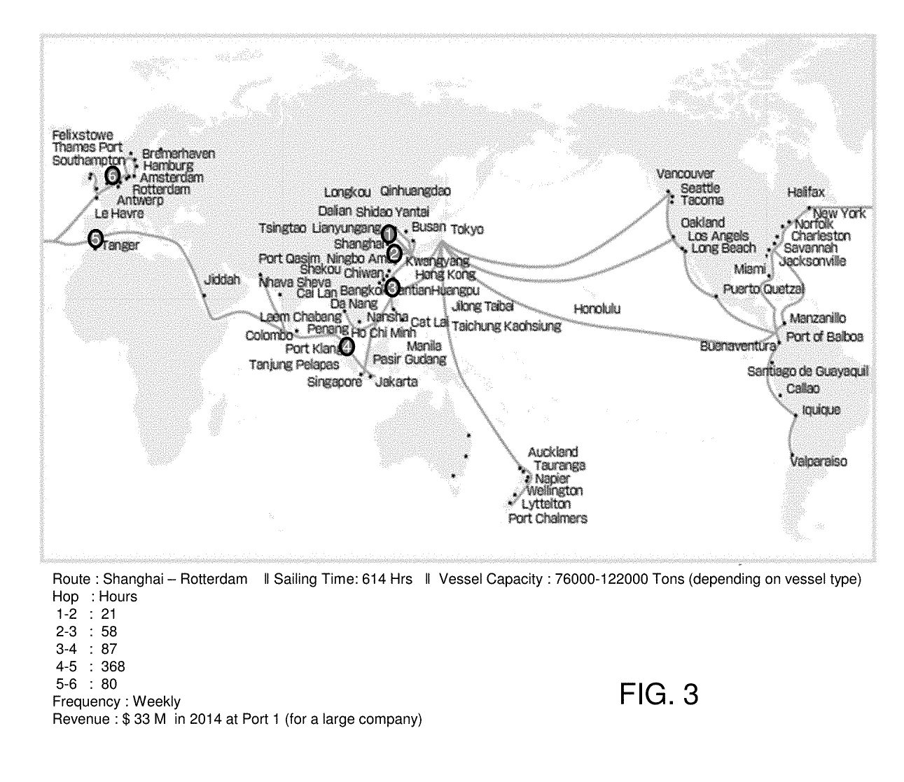

FIG. 3 illustrates an exemplary shipping route for a shipping vessel including shipping information for ports 1-6, which correspond to respective port servers 80-85 illustrated in FIG. 2. Typically, shipping vessels may be stationed at various ports along a shipping route for many hours or days at a time.

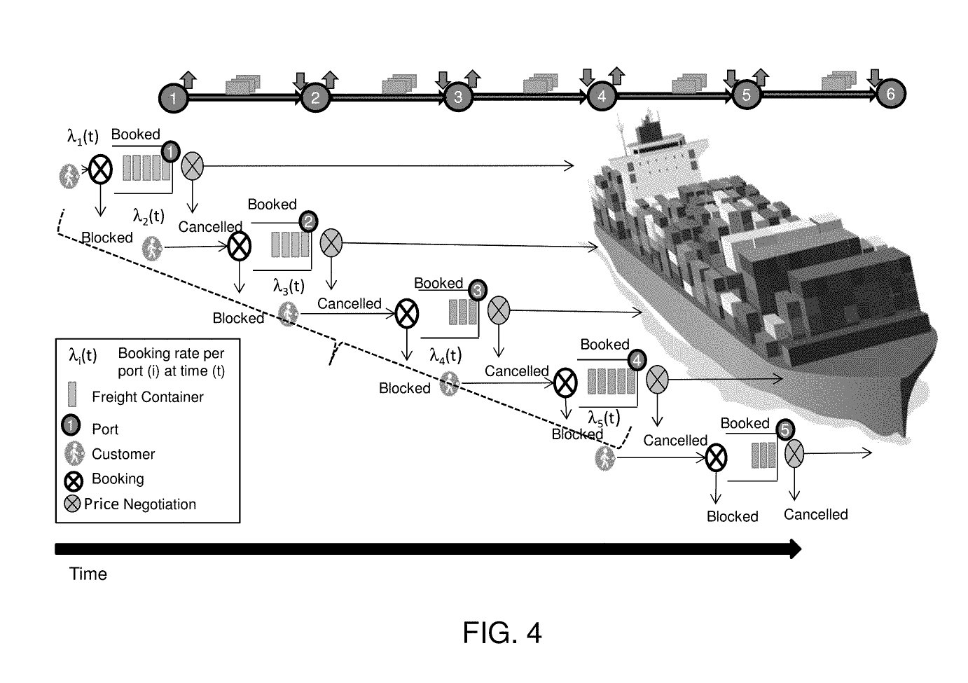

FIG. 4 illustrates a shipping management scenario for a shipping vessel. Typically, customers book an amount of goods to be shipped (e.g., a number of freight containers) with multiple shipping management companies (e.g., shipping management server 90 of FIG. 2) for shipping by a select date, and are provided with an estimated cost for the shipping by each of the shipping management companies. The term booked as used herein refers to the advance reservation of freight shipping services. If a shipping management company determines that no shipping capacity is available, then the customers will be blocked from booking a shipment. The term blocked as used herein refers to the denial of freight shipping services to a customer or customers, or the unavailability of freight shipping services for booking. As the select shipping date approaches, the shipping management companies will provide a final cost for shipping to booked customers. Typically, the shipping management companies will offer discounts to customers, the amount of which is determined by how full the shipping vessel is. That is, if the shipping vessel of a shipping management company is not utilized to its full capacity, the shipping management company may offer discounts to customers or otherwise negotiate prices to incentivize the customers to ship their goods with their shipping management company, so as to maximize utilization of the shipping vessel (and therefore maximize profits). This competitive environment results in some customers cancelling their bookings with a first shipping management company based on receiving a better financial incentive from a competing shipping management company. Customers may also cancel bookings for reasons not related to price negotiations. As the date of departure for a shipping vessel approaches and bookings for a shipping route of a shipping vessel approach capacity (of the shipping vessel) a shipping management company may feel constrained to limit incentives to book due to capacity limitations of the shipping vessel. Presently, shipping management companies are limited in their shipping forecasting tools, and may finalize a smaller number of bookings than they could have finalized (i.e., they leave demand on the table), due to incomplete information and a perceived lack of negotiating power. The present invention provides a system and method whereby the negotiators for shipping management companies may be provided with improved shipping demand information, which takes into account the impact of local price negotiations on shipping demand throughout a shipping route.

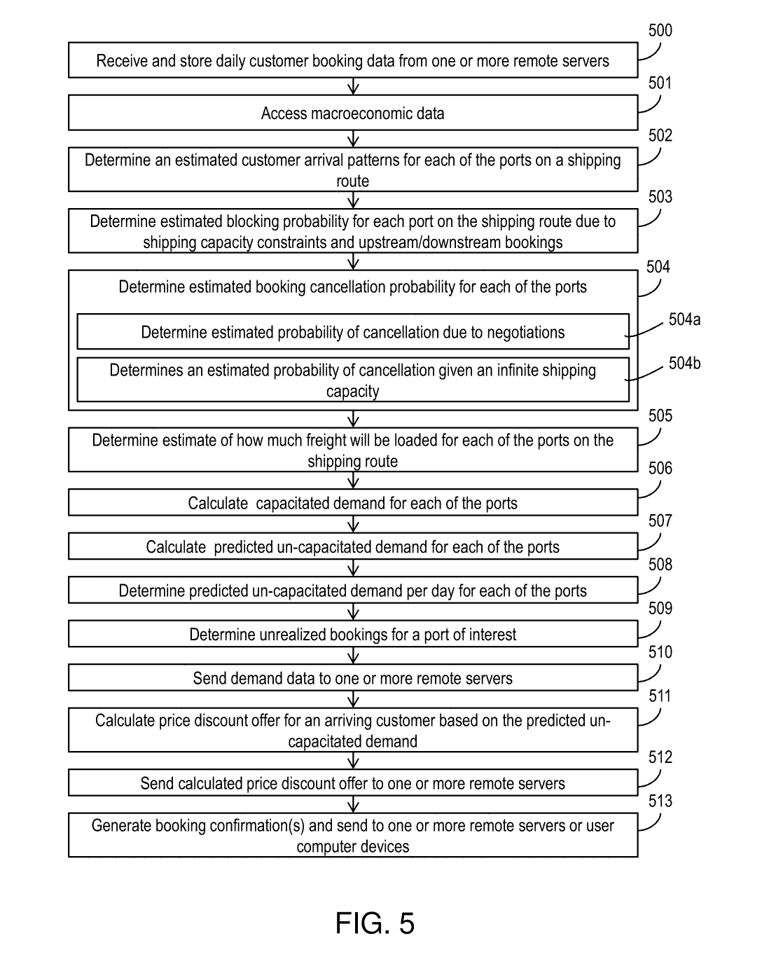

FIG. 5 shows a flowchart of a method in accordance with aspects of the invention. Steps of the method of FIG. 5 may be performed in the environment illustrated in FIG. 2, and are described with reference to elements shown in FIG. 2.

At step 500, the demand server 60 receives customer booking data from one or more remote servers (e.g., shipping management server 90, 91 and/or port servers 80-85 on a shipping route), and stores the customer booking data in the booking database 61. Various methods may be utilized to communicate customer booking data between the demand server 60 and one or more remote servers. In embodiments, each remote server (e.g., shipping management server 90, 91 and/or port servers 80-85) includes an application programming interface (API) function that communicates with the demand server 60. More specifically, the API function may publish shipping data objects to the demand server 60 and communicate requests and responses to and from the demand server 60. The API function may be a software program or function that interfaces and communicates with the demand server 60. Customer booking data may include, for one or more ports on the shipping route, the capacity of one or more shipping vessels, the amount of freight booked (e.g., number of shipping containers) per shipping vessel, dates of bookings, dates of shipments, dates of arrivals per port, ports of origin, order and number of ports visited, ports of final destination, booking window data (e.g., data booking is available to customers and date booking window closes), and/or other shipping data. The term booking window as used herein refers to a window of time (e.g., starting date to ending date) within which a customer may book freight on a particular shipping vessel. The booking data received at step 500 may be utilized by the demand server 60 to perform the remaining steps of FIG. 5, as will be discussed in more detail below. Advantageously, embodiments of the invention enable the collection of real-time customer booking data from multiple remote servers and/or multiple countries along an extensive shipping route (e.g., a sea route) for use in demand forecasting along the shipping route. Real-time analysis of customer booking data may be utilized for time-sensitive price negotiations at a port of interest, as will be discussed in more detail below.

At step 501, the demand server 60 may receive macroeconomic data from one or more macroeconomic data providers (e.g., macroeconomic data provider server 70). In embodiments, the macroeconomic module 62 may receive macroeconomic data and save the data in the macroeconomic database 63. Macroeconomic data may include, for example, data with respect to local holidays, historic shipping trends, seasonal fluctuations in shipping demand for various goods, gross domestic product (GDP) data for port countries, import and export data (e.g., between ports and/or countries), etc.

At step 502, the demand server 60 determines a customer arrival pattern for each port (i) on a shipping route. In embodiments, the demand server 60 determines an estimated customer arrival pattern using a beta distribution superimposed with seasonality. In embodiments, the demand server 60 calculates a maximum likelihood estimate (joint estimation) of parameters of a beta distribution and seasonality. As used herein, the term customer arrival refers to the date a customer starts booking freight (e.g., date shipping container(s) is first reserved). In aspects, freight data utilized in the estimation is cut by industry and port of origin. In embodiments, the demand server 60 evaluates customer arrival lead time distribution per port relative to a vessel departure date. The number of bookings which have happened by X days from departure give a good indication or estimate of the expected arrivals over the next X days. In aspects, customer arrival patterns will be estimated for all downstream ports.

In aspects, the demand server 60 determines distribution parameters (α, γ, θ) that maximizes Σᵢ log((t₁/T)^{α}*(1−tᵢ/T)^{γ}*(1+θ*season)). The variable (t) stands for time, and specifically, arrival lead time. The variable (i) stands for a port of interest on a shipping route. The term arrival lead time as used herein refers to the time remaining in a particular booking window. The time a particular booking window opens or starts is represented herein by (T). The term season as used herein refers to patterns of bookings during a block of time, such as one or more months, and may coincide with typical seasonal divisions of the year (spring, summer, autumn and winter). For example, the term seasonal as used herein may reflect data indicating that there are no bookings during certain weekends or holidays, as well as weekly booking patterns of variation due to the end of the year, etc. In embodiments, step 502 is performed by the likelihood module 64 of the demand server 60.

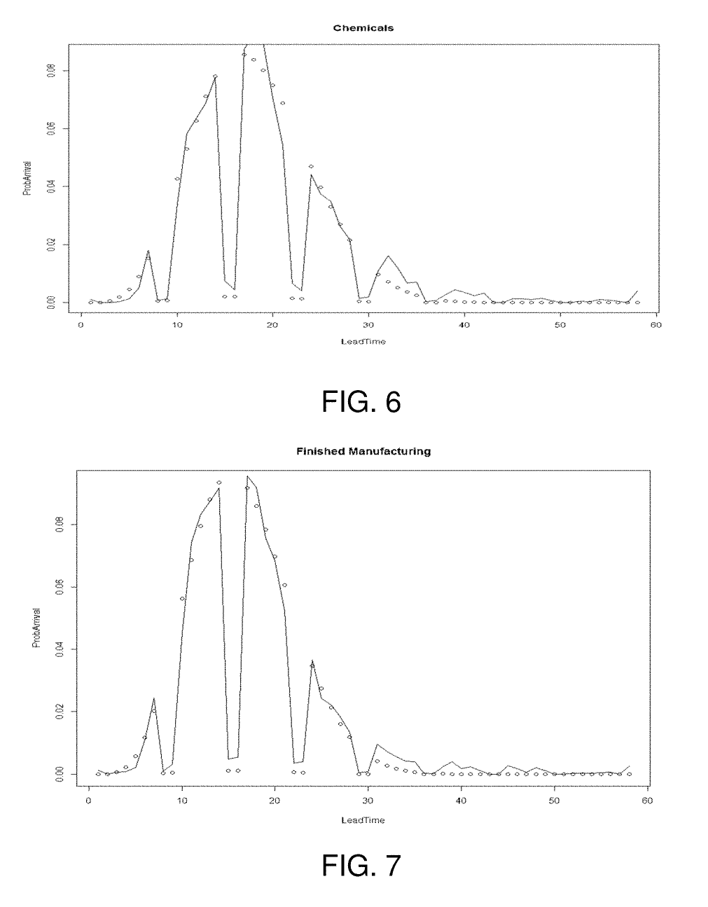

FIG. 6 is a graph representing an estimated distribution of customer booking dates conditional on vessel departure date generated in accordance with step 502 for the shipping of chemicals from a port of interest. Similarly, FIG. 7 is a graph representing an estimated distribution of customer booking dates conditional on vessel departure date generated in accordance with step 502 for the shipping of finished manufacturing products from a port of interest.

With reference back to FIG. 5, at step 503, the demand server 60 determines an estimated blocking probability for each port on a shipping route due to shipping capacity constraints and upstream/downstream bookings. As used herein, the term blocking refers to a potential customer freight booking that cannot occur or is “blocked” due to limitations in shipping capacity (i.e., a customer wanted to book but could not). The term upstream bookings as used herein refers to bookings that occur for the shipping of freight from a port that is before a particular port of interest on a shipping route, while the term downstream bookings as used herein refers to bookings that occur for the shipping of freight from a port that is after the particular port of interest on the shipping route. In aspects, the queuing module 65 of the demand server 60 performs step 503. In embodiments, the demand server 60 initially determines a demand (ν) passing through a hop pair (i, i+1), where the shipping vessel travels between a port (i) and a destination port (i+1). The term hop pair as used herein refers to shipping stops or ports that are next to one another on a shipping route.

All demand (ν) at or before a port (i) which has a destination port (i+1) or beyond at a given time (t) is represented by the equation:

ν=(i,i+1,t).

Vessel utilization at hop pair (i,i+1) at a particular time (t) is represented by the formula:

ρᵢ=(i,i+1,t)/C.

As used herein, the variable (ρ) represents demand divided by capacity (ν/C). Capacity (C) refers to units of capacity of a shipping vessel (e.g., number of shipping containers available per shipping vessel, etc.). The blocking probability at a particular time (t) is given by the Erlang-B formula:

$${PB}_{i} ( t ) = {max}_{ρ i} ( 1 - \frac{( 1 - ρ ) {ρ}^{C}}{1 - {ρ}^{C + 1}} ) .$$

As used herein, PBᵢ(t) represents a blocking probability (PB) for a port (i) at a given time (t). The blocking probability can be understood as the fraction of arriving customers who are rejected or blocked (prevented from booking freight) due to capacity constraints of C units. Conversely, the fraction of arriving customers who will be booked at a given time (t) is represented by:

(1−PBᵢ(t)).

At step 504, the demand server 60 determines an estimated booking cancellation probability for each port on a shipping route. In embodiments, the demand server estimates booking cancellation probability based on both a probability of cancellation due to potential negotiations between the shipping management company and a customer, and a probability of cancellation given an infinite shipping capacity. These two steps are represented by steps 504a and 504b in FIG. 5.

At step 504a, the demand server 60 determines an estimated probability of cancellation due to negotiations. In other words, the demand server 60 determines an estimated probability of booking cancellations based on the estimated bargaining position of the customer and a shipping management company using a non-linear regression method. In aspects, the queuing module 65 of the demand server 60 performs step 504a. In embodiments, a non-linear regression model is utilized to build relationships between cancellation rates, bookings and utilization rate of an incoming shipping vessel utilizing the following equation:

PCᵢ(t)˜G(Bookingᵢ(t),Utilization₍ᵢ₋₁₎(t))=θᵢ(Bookingᵢ(t))^{σ}(1+Utilization₍ᵢ₋₁₎(t))^{ε}.

In the above equation, the cancellation rate (PC) at a port (i) at a given time (t) is approximately equal to the utilization rate (G), where the term “booking” represents the number of shipping units (e.g., shipping containers) booked and the term “utilization” is represented by the formula:

ρᵢ(t)=ν(i,i+1,t)/C.

Still referencing FIG. 5, at step 504b the demand server 60 determines an estimated probability of cancellation (un-capacitated cancellation probability) given an infinite shipping capacity. In aspects, the queuing module 65 of the demand server 60 performs step 504b. This estimation represents the case where there are no negotiations between a customer and a shipping manager. As the shipping capacity of an imaginary shipping vessel increases to infinity, the following can be observed:

Utilization₍ᵢ₋₁₎(t)→0

The estimated un-capacitated cancellation probability accounts for all cancellations due to random effects (e.g., not due to negotiations based on prices tied to available capacity). For example, some customers will cancel a booking for reasons not tied to pricing. The un-capacitated probability of cancellation (RC) for a port (i) at a given time (t) is represented by the formula:

RCᵢ(t)˜G(Bookingᵢ(t),0)=θ₁(Bookingᵢ(t))^{σ}

At step 505, the demand server 60 determines an estimate of how much freight will be loaded for a particular shipping vessel for each of the ports on a shipping route. In aspects, this loaded demand will be the actual carried load from a port as available from historic data (e.g., data received at step 500). In embodiments, the ARMA module 66 of the demand server 60 performs step 505. The total estimated freight loaded on a shipping vessel departing at a time (t) with (T) units of a booking window is represented by the formula:

λᵢ(t)*T*(1−PBᵢ(t))*(1−PCᵢ(t)).

As used herein, λᵢ(t) represents the rate of booking for a port (i) at the time (t) (i.e., estimated customer arrival rate).

In embodiments, the demand server 60 may utilize macroeconomic data received at step 501 to estimate the freight to be booked. In aspects, external data received on rate of growth of Gross Domestic Product (GDP) for a countries associated with a ports (i) and (j) and exports and imports between countries owning the ports (i) and (j) may be utilized to estimate the total amount of freight to be loaded. In embodiments, the following ARMA models may be utilized:

λᵢ(t+1)=αλᵢ(t)+βΔGDPᵢ(t)+ηΔExportᵢ(t);

F_{i,j}(t+1)=μF_{i,j}(t)+ηΔExport_{i,j}(t).

In the formulas listed above, λᵢ(t+1) represents future rates of bookings at a port (i) at a future time (t+1); λᵢ(t) represents a rate of booking at a port (i) at a time (t); ΔGDPᵢ(t) represents a change in GDP for the port (i) at the time (t); and ΔExport_{i,j}(t) represents a change in exports between the ports (i) and (j) at the time (t). Variables α, β and η are coefficients of the regression model. Similarly, F_{i,j}(t+1) represents estimated future booked freight (F) between the ports (i) and (j) at a future time (t+1); μ F_{i,j} (t) represents freight between the ports (i) and (j) at the time (t); and h ΔExport_{i,j}(t) represents the change in exports between the ports (i) and (j) at the time (t).

At step 506, the demand server 60 calculates capacitative demand for each of the ports on the shipping route. In aspects, the demand module 67 of the demand server 60 performs step 506. In embodiments, the capacitated carried freight load (Lᵢ(t)) is determined using observed data (historic shipping data from step 500). Data is observed only at the time of departure (t) of a shipping vessel from a port (i): the time is discrete. The model arrival rate is represented by λᵢ(t). In embodiments, observed arrivals are sampled from the Poisson distribution with rate λᵢ(t), wherein:

$$Probability ( {L}_{i} ( t ) = 1 ) = \frac{exp ( - {λ}_{i} ( t ) ) {( {λ}_{i} ( t ) )}^{l}}{factorial ( l )}$$

In embodiments, the Markov Chain Monte Carlo (MCMC) method with Metropolis algorithm is utilized to estimate model parameters (α, β, η, μ, λ(0), θ₁, ε, σ) that maximizes the posteriori (conditional) probability.

Probability(α,β,η,μ,λ(0),θ₁,ε,σ|Lᵢ(t):for all t & i).

At step 507, the demand server 60 calculates un-capacitated demand for each of the ports on a shipping route. In aspects, the demand module 67 of the demand server 60 performs step 507. In embodiments, predicted un-capacitated demand is obtained using the estimated parameter values in the given formula:

λᵢ(t)*T*(1−RCᵢ(t)).

As used herein, arrival rate is represented by λᵢ(t), the parameter (T) represents the time a particular booking window opens or starts; and RCᵢ(t) represents the un-capacitated probability of cancellation (RC) for a port (i) at a given time (t). The un-capacitive demand represents booking arrivals that are not blocked due to capacitive constraints. In the un-capacitated demand calculation, bookings are not cancelled due to negotiating power influenced by the amount of capacity available.

At step 508 of FIG. 5, the demand server 60 determines predicted un-capacitated demand per day (daily customer arrivals) for each of the ports in a shipping route. In embodiments, the demand server 60 convolves the predicted un-capacitated demand determined at step 507 with the estimated arrival pattern determined at step 502 to determine the predicted daily customer arrivals. The proportion of the shipping container type required per industry yields the demand for each container type.

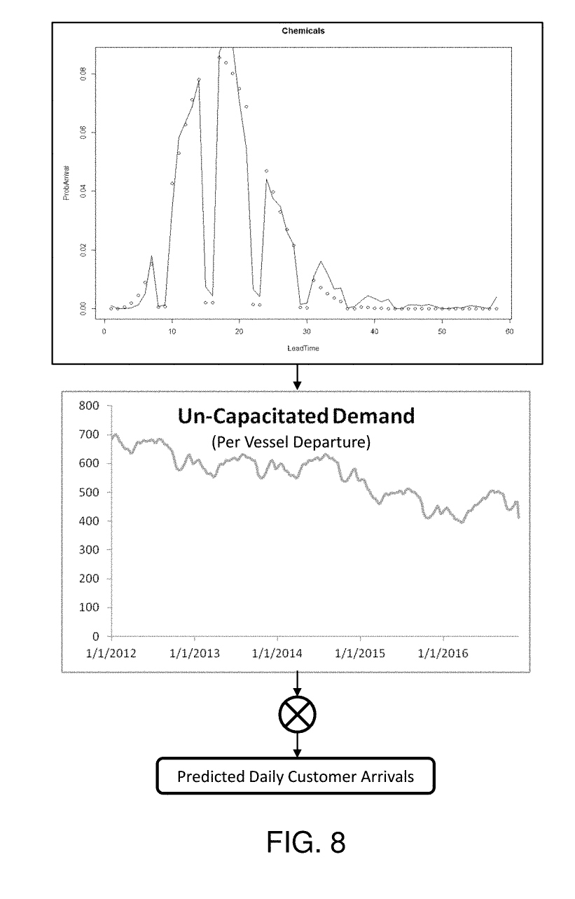

FIG. 8 depicts the use of estimated customer arrival patterns of FIG. 6 (determined in accordance with step 502 of FIG. 5) and the un-capacitated demand per shipping vessel departure (in accordance with step 507 of FIG. 5), to predict daily customer arrivals (in accordance with step 508 of FIG. 5) for a port of interest.

Referring back to FIG. 5, at step 509, the demand server 90 may determine unrealized bookings by comparing the capacitated demand determined at step 506 to the un-capacitated demand determined at step 507.

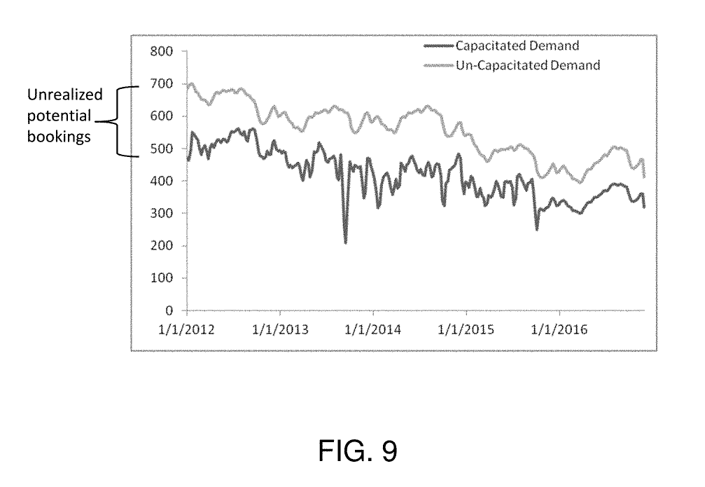

FIG. 9 depicts unrealized potential bookings for a port of interest as the difference between the determined capacitated demand (step 506 of FIG. 5) and the determined un-capacitated demand (step 507 of FIG. 5). It should be understood that the difference between the capacitated demand curve and the un-capacitated demand curve represents demand that was left on the table by a shipping management company for a particular shipping vessel.

Referring back to FIG. 5, at step 510, the demand server 60 may send data determined at any of steps 502-509 to one or more shipping management companies (e.g., shipping management servers 90 and 91). In embodiments, the demand server 60 sends the daily customer arrivals determined at step 509 of FIG. 5 to a remote shipping management server (e.g., 90, 91) in real-time, which causes the remote shipping management server to display the daily customer arrival data. The demander server 60 may send data relevant to all ports in a shipping route, or may send only data relevant to a port of interest in the shipping route. In embodiments, the demand server 60 may send demand data to one or more shipping management companies upon receiving a request from the one or more shipping management companies or other client(s) for the demand data, such as through communication with an API function of a shipping management server 90, 91.

At step 511, the demand server 60 may calculate a price discount offer for an arriving customer at a port of interest based on the predicted un-capacitated demand determined at step 507. In embodiments, a price discount offered to an arriving customer at a particular port of interest in a shipping route may be based on the following. At a time t, when a customer arrives for a final price negotiation with a business manager at a port of interest (j); predicted un-capacitated demand at port k is D(k,t); the sold capacity at port k is S(k,t); and the total unsold open bookings at port k is B(k,t); then the price discount offered to the arriving customer is based on the value of:

R(k,t)=[D(k,t)/(S(k,t)*B(k,t))]/[sum(k in downstream)D(k,t)/(S(k,t)*B(k,t))].

If R(k,t)>threshold (1) then the discount offered is d(1), which is proportional to the corresponding threshold (Threshold(1)).

At step 512, the demand server 60 may send the calculated price discount offer determined at step 511 to one or more remote servers (e.g., shipping management servers 90, 91) in real-time. Such information may be sent to a remote client server prior to the end of a booking window, for display by the remote client server, to utilized in the real-time negotiation of freight shipping prices by shipping managers. It should be understood that steps 511 and/or 512 may be implemented in response to a request received from one or more remote servers (e.g., a request received from shipping management server 90 or 91), such as through communication with an API of the one or more remote servers. Alternatively, step 511 may be performed by a shipping management server 90, 91 based on demand data received from the demand server 60 at step 510.

At step 513, the demand server 60 may generate one or more booking confirmation documents and send them to shipping management servers 90, 91, user computer devices 92, and/or one or more port servers 80-85. In embodiments, the one or more booking confirmations are in the form of a digital document including details of the parties involved in the shipping agreement, details of the price of the booking, details of the shipping arrangements, dates of shipping, and/or other data related to the generation of a booking confirmation document. In aspects, the demand server 60 may recognize a threshold level price discount value at which a customer has agreed to finalize a booking transaction. In such cases, the demand server 60 may compare the price discount offer calculated at step 511 with a customer database of stored threshold values associated with respective booking customers. Upon determining that the price discount offer meets the predetermined threshold value, the demand server 60 may automatically generate one or more booking confirmations in accordance with step 513, and send the booking confirmations to the customer or responsible party (e.g., user computer devices 92 of consumers or companies booking the shipping containers, user computer devices 92 of third party booking agents, and/or shipping management servers 90, 91). In embodiments, data for the customer database may be received at step 500.

In one example, a customer books a shipping container through a shipping management company, and the shipping management server 90 of the shipping management company sends the customer booking data for the booking to the demand server 60, including data regarding a discount threshold value at which the customer is willing to lock-in or confirm a booking. After determining a price discount offer for an arriving customer based on the predicted uncapacitated demand at step 511, the demand server 60 may compare the price discount offer with the threshold value received at step 500. Upon determining that the price discount offer meets the customer's threshold value for locking-in the agreement, the demand server 60 automatically generates a digital booking confirmation document for distribution to the necessary parties (e.g., the shipping management company and/or directly to a user computer device 92 of the customer).

It should also be understood that the method of FIG. 5 can apply to freight or cargo conveyed by ship (e.g., sea freight), aircraft, train, or other methods, and is not intended to be limited to only shipment via watercraft. Based on the above, embodiments of the present invention provide for predicting un-capacitated freight demand on multi-hop route from cargo load data by: predicting a number of new customers for each o-d pair on a route with vessels having infinite carrying capacity; performing a queuing analytics method to estimate “unobservable” customer blocking probability (customers who wanted to book but could not) due to vessel capacity constraint and existing up-stream/down-stream bookings with customer as an indivisible entity; performing a method to estimate booking cancellation probability based on estimated bargaining position of the customer and the company using a non-linear regression method and an asymptotic limit argument; utilizing a Markov chain Monte Carlo method to estimate parameters of the un-capacitated demand model from observed carried load data and predict un-capacitated demand per vessel using external rate of change in export-import between countries and their GDP, capacitated cancellation rates and estimated blocking probabilities on each hop of the route; and perform a maximum likelihood method to estimate customer arrivals pattern using a beta distribution superimposed with the seasonality followed by a convolution method to predict un-capacitated demand per day based on the predicted un-capacitated vessel demand.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still another embodiment, the invention provides a computer-implemented method for predicting un-capacitated freight demand on a multi-hop shipping route. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computing device, daily customer booking data from one or more remote servers;
determining, by the computing device, an estimated customer arrival pattern for each port on a shipping route of a shipping vessel based on the customer booking data;
determining, by the computing device, an estimated blocking probability for each of the ports on the shipping route due to shipping capacity constraints, upstream bookings and downstream bookings;
determining, by the computing device, an estimated probability of booking cancellations for each of the ports on the shipping route;
determining, by the computing device, an estimate of how much freight will be loaded onto the shipping vessel for each of the ports on the shipping route;
calculating, by the computing device, un-capacitated shipping demand for each of the ports on the shipping route; and
determining, by the computing device, un-capacitated demand per day for each of the ports of the shipping route based on the capacitated demand and the estimated customer arrival pattern.

2. The method of claim 1, wherein the determining the estimated probability of booking cancellations comprises:
determining, by the computing device, an estimated probability of cancellation given a capacity of a shipping vessel; and
determining, by the computing device, an estimated probability of cancellation given an infinite shipping capacity.

3. The method of claim 1, further comprising receiving, by the computing device, macroeconomic data regarding one or more ports along a shipping route of a shipping vessel, wherein the macroeconomic data is utilized in the determining the estimate of how much freight will be loaded onto the shipping vessel for each of the ports on the shipping route.

4. The method of claim 1, further comprising:
calculating, by the computing device, a price discount offer for a customer based on the predicted un-capacitated demand;
determining, by the computing device, that the price discount offer meets a predetermined threshold value associated with the customer; and
automatically generating, by the computing device, a booking confirmation document including details regarding a booking of the customer based on the determining that the price discount offer meets the threshold value.

5. The method of claim 1, further comprising sending, by the computing device, the un-capacitated demand per day for at least one of the ports of the shipping route based to a remote server of a client.

6. The method of claim 1, further comprising:
calculating, by the computing device, a price discount offer for an arriving customer at least one of the ports of the shipping route based on the un-capacitated shipping demand; and
sending, by the computing device, the price discount offer to a remote server of a client.

7. The method of claim 1, wherein the receiving daily customer booking data comprises receiving daily customer booking data for multiple ports along the shipping route.

8. A computer program product for predicting un-capacitated freight demand on a multi-hop shipping route, the computer program product comprising a computer readable storage medium having program instructions embodied therewith, the program instructions executable by a computing device to cause the computing device to:
determine an estimated customer arrival pattern for each port on a shipping route of a shipping vessel by calculating a maximum likelihood estimate of parameters of a beta distribution and seasonality booking patterns;
determine an estimated blocking probability for each of the ports on the shipping route due to shipping capacity constraints, upstream bookings and downstream bookings;
determine an estimated probability of booking cancellations for each of the ports on the shipping route;
determine an estimate of how much freight will be loaded onto the shipping vessel for each of the ports on the shipping route;
calculate un-capacitated shipping demand for each of the ports on the shipping route; and
determine un-capacitated demand per day for each of the ports of the shipping route by convolving the determined un-capacitated demand and the determined estimated customer arrival pattern.

9. The computer program product of claim 8, wherein the program instructions further cause the computing device to receive booking data from a remote server of a client in real time, wherein the determining the un-capacitated demand per day for each of the ports of the shipping route is based on the real-time booking data.

10. The computer program product of claim 8, wherein the determining the estimated probability of booking cancellations comprises:
determining an estimated probability of cancellation given a capacity of a shipping vessel; and
determining an estimated probability of cancellation given an infinite shipping capacity.

11. The computer program product of claim 8, wherein the program instructions further cause the computing device to receive macroeconomic data regarding one or more ports along a shipping route of a shipping vessel, wherein the macroeconomic data is utilized in the determining the estimate of how much freight will be loaded onto the shipping vessel for each of the ports on the shipping route.

12. The computer program product of claim 8, wherein the program instructions further cause the computing device to send the un-capacitated demand per day for at least one of the ports of the shipping route based to a remote server of a client.

13. The computer program product of claim 8, wherein the program instructions further cause the computing device to:
calculate a price discount offer for an arriving customer at least one of the ports of the shipping route based on the un-capacitated shipping demand; and
determine that the price discount offer meets a predetermined threshold value associated with the arriving customer; and
automatically generate a booking confirmation document including details regarding a booking of the arriving customer based on the determining that the price discount offer meets the threshold value.

14. A system for predicting un-capacitated freight demand on a multi-hop shipping route, comprising:
a CPU, a computer readable memory and a computer readable storage medium associated with a computing device;
program instructions to receive daily customer booking data from one or more remote client servers, the booking data including observed carried load data;
program instructions to determine an estimated customer arrival pattern for each port on a shipping route of a shipping vessel by calculating a maximum likelihood estimate of parameters of a beta distribution and seasonality booking patterns;
program instructions to determine an estimated blocking probability for each of the ports on the shipping route due to shipping capacity constraints, upstream bookings and downstream bookings;
program instructions to determine an estimated probability of booking cancellations for each of the ports on the shipping route based on estimated bargaining positions of a customer and a booking company using a non-linear regression method and asymptotic limit argument;
program instructions to determine an estimate of how much freight will be loaded onto the shipping vessel for each of the ports on the shipping route based on observed carried load data;
program instructions to calculate un-capacitated shipping demand for each of the ports on the shipping route; and
program instructions to determine un-capacitated demand per day for each of the ports of the shipping route by convolving the determined un-capacitated demand and the determined estimated customer arrival pattern;
wherein the program instructions are stored on the computer readable storage medium for execution by the CPU via the computer readable memory.

15. The system of claim 14, wherein the program instructions to determine the estimated probability of booking cancellations comprises:
program instructions to determine an estimated probability of cancellation given a capacity of a shipping vessel; and
program instructions to determine an estimated probability of cancellation given an infinite shipping capacity.

16. The system of claim 14, further comprising program instructions to receive macroeconomic data regarding one or more ports along a shipping route of a shipping vessel, wherein the macroeconomic data is utilized in the determining the estimate of how much freight will be loaded onto the shipping vessel for each of the ports on the shipping route.

17. The system of claim 16, wherein the macroeconomic data includes gross domestic product data for one or more countries associated with the one or more ports along the shipping route.

18. The system of claim 14, further comprising program instructions to send the un-capacitated demand per day for at least one of the ports of the shipping route to a remote server of a client based on a request received from the remote server.

19. The system of claim 14, further comprising:
program instructions to calculate a price discount offer for an arriving customer at least one of the ports of the shipping route based on the un-capacitated shipping demand;
program instructions to determine that the price discount offer meets a predetermined threshold value associated with the arriving customer;
program instructions to automatically generate a booking confirmation document including details regarding a booking of the arriving customer based on the determining that the price discount offer meets the threshold value; and
program instructions to sent the booking confirmation to a remote computing device of the arriving customer.

20. The system of claim 14, wherein the receiving daily customer booking data comprises receiving daily customer booking data for multiple ports along the shipping route from multiple remote servers.
